(19) United States
(12) Patent Application Publication
(10) Pub. No.: US 2011/0153650 A1
(43) Pub. Date: Jun. 23, 2011

(54) COLUMN-BASED DATA MANAGING METHOD AND APPARATUS, AND COLUMN-BASED DATA SEARCHING METHOD

(75) Inventors: Hun Soon Lee, Daejeon (KR); Mi Young Lee, Daejeon (KR)

(73) Assignee: Electronics and Telecommunications Research Institute, Daejeon (KR)

(21) Appl. No.: 12/838,917

(22) Filed: Jul. 19, 2010

(30) Foreign Application Priority Data
Dec. 18, 2009 (KR) 10-2009-0127351
Mar. 31, 2010 (KR) 10-2010-0029136

(51) Int. Cl. G06F 12/06; G06F 17/30

(52) U.S. Cl. 707/769; 711/173; 707/E17.014; 711/E12.084

(57) ABSTRACT

Disclosed are a column-based data managing method and apparatus, and a column-based data searching method. The column-based data managing method includes determining whether the size of the column-group data file exceeds a partitioning threshold, dividing the column-group data if the size exceeds the partitioning threshold, and generating divided column-group data files.

### CROSS-REFERENCE TO RELATED APPLICATIONS

This application claims priority under 35 U.S.C. §119 to Korean Patent Application No. 10-2009-0127351, filed on Dec. 18, 2009, and Korean Patent Application No. 10-2010-0029136, filed on Mar. 31, 2010 in the Korean Intellectual Property Office, the disclosure of which is incorporated herein by reference in its entirety.

### BACKGROUND OF THE INVENTION

1. Field of the Invention

The present invention relates to a column-based data managing method and apparatus, and a column-based data searching method, and more particularly, to a technology of effectively supporting management of massive column data in a column-based data storage device that manages massive data by using a plurality of computing nodes.

2. Description of the Related Art

Known column-based data managing apparatuses and methods divide a partition with respect to rows when the size of the largest column-group data file in a partition is in excess of a predetermined partitioning threshold and thus the size of the column-group data file is limited to the partitioning threshold. Accordingly, the known column-based data managing apparatuses and methods fail to effectively manage rows having a size larger than the partitioning threshold.

### SUMMARY OF THE INVENTION

Embodiments of the present invention may provide column-based data managing apparatus and method that, when the size of column-group data in a single row partition exceeds a partitioning threshold, divide the column-group data and thus effectively manage the column-based data.

The present invention is not limited to the above embodiments, but a diversity of modifications and variations are available.

According to an aspect of the present invention, there is provided a column-based data managing method including: after compaction is performed on all of the column-group data files within a partition, determining whether the size of the column-group data file exceeds a partitioning threshold; dividing the column-group data if the size exceeds the partitioning threshold; and generating divided column-group data files.

According to another aspect of the present invention, there is provided a column-based data managing apparatus including: a determining unit that the size of the largest one of column-group data files within the partition exceeds to a partitioning threshold, after compaction is performed on all of the column-group data files within a partition; a dividing unit that, in the case of exceeding the partitioning threshold, divides the column-group data; and a generating unit that generates divided column-group data files.

According to another aspect of the present invention, there is provided a column-based data searching method to search for divided column-group data files using a column-based data managing method in order to find user interesting data, the searching method including: obtaining a list of divided column-group data files constituting a partition; determining whether each divided column-group data file in the list includes user interesting data; removing divided column-group data files that do not include the user interesting data to obtain a corrected list; and searching for the user interesting data using the corrected list.

Other embodiments of the present invention will be described with reference to accompanying drawings.

According to an embodiment of the present invention, the column-based data managing apparatus and method may divide the column-group data and thus effectively manage the column-based data when the size of column-group data in a single row partition exceeds a partitioning threshold.

Further, the column-based data searching method may search for user interesting data using a corrected list from which divided column-group data files not containing the user interesting data have been excluded, thus enabling effective column-based data management.

### BRIEF DESCRIPTIONS OF THE DRAWINGS

FIG. 1 is a view illustrating a concept of a data storing and serving model of a column-based data managing system;

FIG. 2 is a view illustrating an example of data storage by a column-based data managing system;

FIG. 3 is a flowchart illustrating a column-based data managing method according to an embodiment of the present invention;

FIG. 4 is a flowchart illustrating a column-based data managing method according to another embodiment of the present invention;

FIG. 5 is a flowchart illustrating a column-based data managing method according to another embodiment of the present invention;

FIG. 6 is a flowchart illustrating a method of dividing a column-group data file with respect to middle key in a column-based data managing apparatus and method according to another embodiment of the present invention;

FIG. 7 is a view illustrating an example of dividing a column-group data in a column-based data managing apparatus and method according to another embodiment of the present invention;

FIG. 8 is a flowchart illustrating a column-based data managing method according to another embodiment of the present invention;

FIG. 9 is a block diagram illustrating a column-based data searching apparatus according to another embodiment of the present invention;

FIG. 10 is a block diagram illustrating a column-based data searching apparatus according to another embodiment of the present invention;

FIG. 11 is a flowchart illustrating a column-based data searching method according to another embodiment of the present invention;

FIG. 12 is a flowchart illustrating a method of determining whether a divided column-group data file includes user interesting data in a column-based data searching method according to another embodiment of the present invention; and

FIG. 13 is a view illustrating an example of a method of determining whether a divided column-group data file includes user interesting data in a column-based data searching method according to another embodiment of the present invention.

### DETAILED DESCRIPTION OF THE PREFERRED EMBODIMENTS

Advantages and features of the present invention and methods to achieve them will be elucidated from exemplary embodiments described below in detail with reference to the accompanying drawings. However, the present invention is not limited to exemplary embodiment disclosed herein but will be implemented in various forms. The exemplary embodiments are provided by way of example only so that a person of ordinary skill in the art can fully understand the disclosures of the present invention and the scope of the present invention. Therefore, the present invention will be defined only by the scope of the appended claims. Meanwhile, terms used in the present invention are to explain exemplary embodiments rather than limiting the present invention. In the specification, a singular type may also be used as a plural type unless stated specifically. “Comprises” and/or “comprising” used herein does not exclude the existence or addition of one or more other components, steps, operations and/or elements.

Hereinafter, an embodiment of the present invention will be described with reference to accompanying drawings.

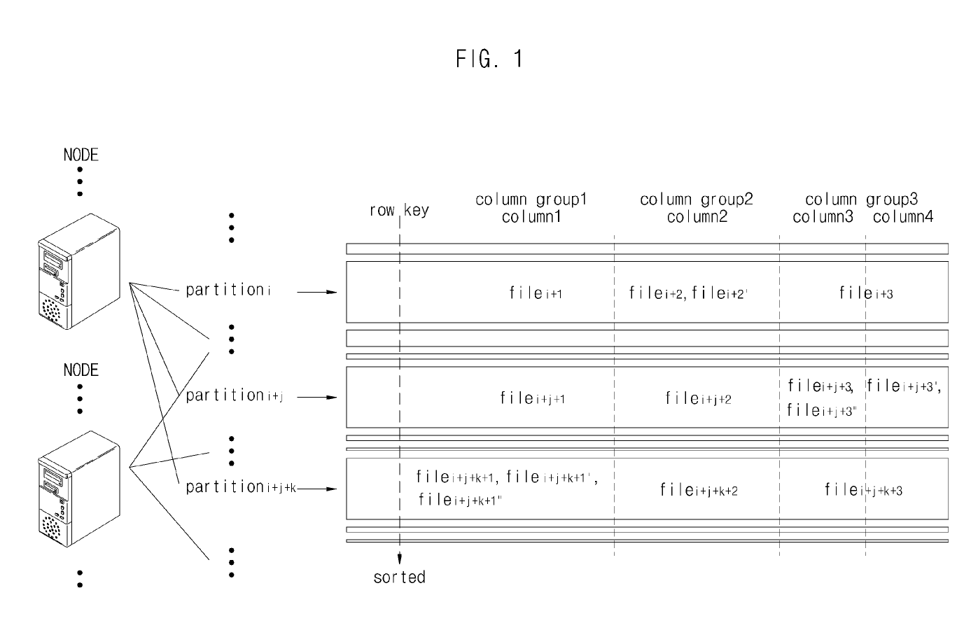

A data storing and serving model of a column-based data managing system will be described with reference to FIG. 1. FIG. 1 is a view illustrating a concept of a data storing and serving model of a column-based data managing system.

Embodiments of the present invention describe a column-based data managing apparatus and method that allows a column-based data managing system to support management of massive column data.

The column-based data managing system is merely an example for more easily understanding the present invention and does not intends to limit the present invention.

Data may be stored in a column-oriented storage manner or row-oriented storage manner. Referring to FIG. 1, the column-based data managing system groups the data into several column-groups and stores the data in a column-oriented storage manner. The term “column-group” means a group of columns that are highly likely to be approachable to each other. Besides grouping the data to several column-groups in order to store the data in the column-oriented storage manner, the column-based data managing system groups the data into several partitions, each of which includes a plurality of rows, so that the data may have a certain size.

Further, the column-based data managing system assigns a service responsibility to a specific partition to a certain node(server) so that service may be simultaneously provided for several partitions. One partition is serviced by one node and one node is in charge of service of a plurality of partitions.

The column-based data managing system assigns update buffer to a memory for each column-group of a partition to manage a change of data. Upon reaching a predetermined size or laps of predetermined time, the update buffer is periodically recorded to a disc. That is, data for one column-group included in one partition is stored and managed in one or more file. This file is called “column-group data file”.

If the number of column-group data files for a group in a partition exceeds a certain number, then a compaction process is performed to remove meaningless data to optimally use a storage space and make the column-group data files into a single file. If the column-group data file subjected to the compaction process is in excess of a partitioning threshold in size, partitioning is performed with respect to rows. The partitioning is conducted on all of the column-groups within the divided partition. The reason why the partition is maintained to have a certain level of size is that when a plurality of partitions are serviced through a plurality of servers, load to the servers may be uniformly distributed so that each server may have similar response time to that of the other servers in responding to a user's search request.

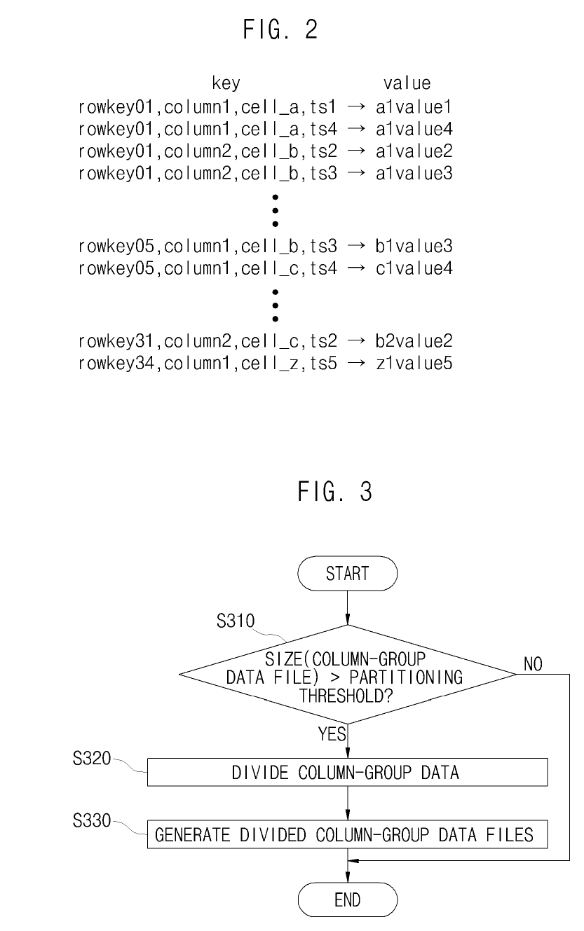

Data storage by the column-based data managing system will be described with reference to FIG. 2. FIG. 2 is a view illustrating an example of data storage by a column-based data managing system.

The column-based data managing system provides a multi-dimensional map structure data model specialized in an

Internet service. A map structure means data is managed in the form of “{key, value}” pairs. Map structure table data are sorted and managed on the basis of a row key and accessible to a specific column of data by using a column name. A specific column may be a data set that includes a value or plural values. If a specific column of data is configured as a data set, the data unit is referred to as “cell”. The cell includes a key and a value. One cell includes multiple versions of values. In the map structure data model, a specific value may be denoted by using “{row key, column key, cell key, timestamp}” as a key value.

FIG. 2 exemplifies a case of storing data with a specific value using {row key, column name, cell key, timestamp} as key values in a map structure data model. For example, “b1value3” is stored by using a row key of “rowkey05”, a column name of “column1”, a cell key of “cell_b”, and a timestamp of “ts3” as keys.

In the multi-dimensional map structure data model of the column-based data managing system, data stored and managed in a specific column of a specific row may be a set of cells, and each cell may have one or more versions. Accordingly, there might be a case where the amount of data included in a specific column-group as denoted in a row increases and thus the size of a specific column-group data file may be larger than a partitioning threshold. However, the known method doesn't consider a situation where the size of data of a certain column-group within a row becomes larger than the partitioning threshold. Accordingly, the known method had a problem of being not capable of effectively managing a row having a larger size than the partitioning threshold since the column-group data stored and manageable in a specific column-group of a row may be limited to the partitioning threshold.

An embodiment of the present invention will be described with reference to FIG. 3. FIG. 3 is a flowchart illustrating a column-based data managing method according to an embodiment of the present invention.

The column-based data managing method according to the embodiment includes a determining step (S310), a dividing step (S320), and a generating step (S330).
The determining step (S310) determines whether in a partition having one or more column-group data, the size of column-group data file exceeds a partitioning threshold.

The dividing step (S320) divides the column-group data when in the determining step, the size of the column-group data file is determined to exceed the partitioning threshold.

The generating step (S330) generates divided column-group data files according to the dividing.
When the column-group data file has a size larger than the partitioning threshold, the column-based data managing method may divide the column-group data and effectively manage the column-based data.

The determining step (S310) may include the step of determining the size of largest one, among the column-group data files after a compaction process, is in excess of the partitioning threshold.

The dividing step (S320) may include the step of repetitively dividing a column-group data until the column-group data file has a size smaller than the partitioning threshold.

The generating step (S330) may include allowing the name of the divided column group data file to contain at least one of a row key, a column name, and a cell key of the column group data before dividing upon generating the divided column group data file.

For example, by dividing the column-group data of a column-group data file referred to as “foo,,,”, a divided column-group data file with the name of “foo, rowkey1, column1, cell_as” may be generated.

Further, the generating step (S330) may include allowing the name of the divided column-group data file to contain information on the range of column-group data upon generating the divided column-group data file.

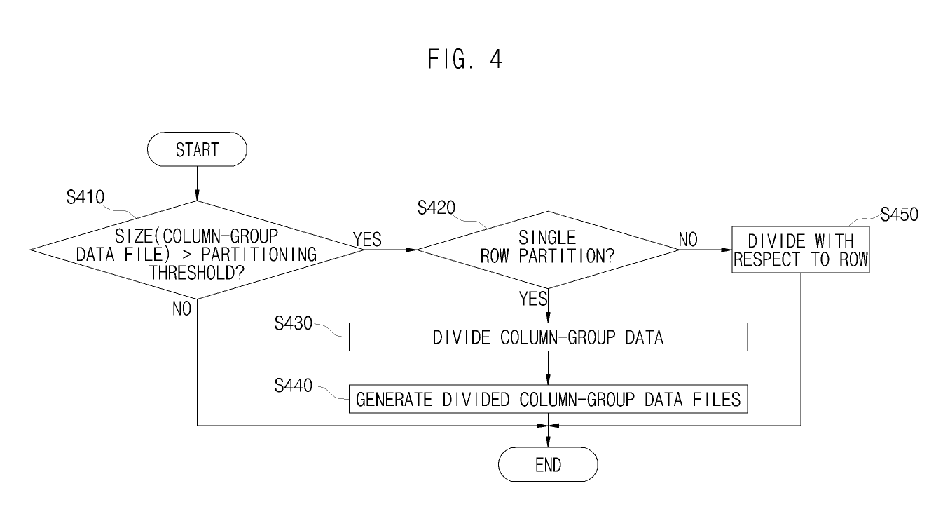

Another embodiment of the present invention will be described with reference to FIG. 4. FIG. 4 is a flowchart illustrating a column-based data managing method according to another embodiment of the present invention.

Referring to FIG. 4, the column-based data managing method according to the embodiment determines whether the size of a column-group data file exceeds a partitioning threshold within a partition including one or more column-group data (S410). If the size is determined to exceed the partitioning threshold, the column-group data is determined to correspond to a partition consisting of a single row (S420), and if the single row partition, the column-group data is divided (S430) to generate a divided column-group data files (S440). Unless the partition is single-row partition, the partition is divided with respect to the row (S450).

Accordingly, when the size of column-group data file of a single-row partition is larger than the partitioning threshold, the column-based data managing method may divide the column-group data and thus effectively manage the column-based data. Further, the method may solve a problem that the size of column-group data is limited to the partitioning threshold in the case of a single-row partition and allows for effective management of a row having a size larger than the partitioning threshold.

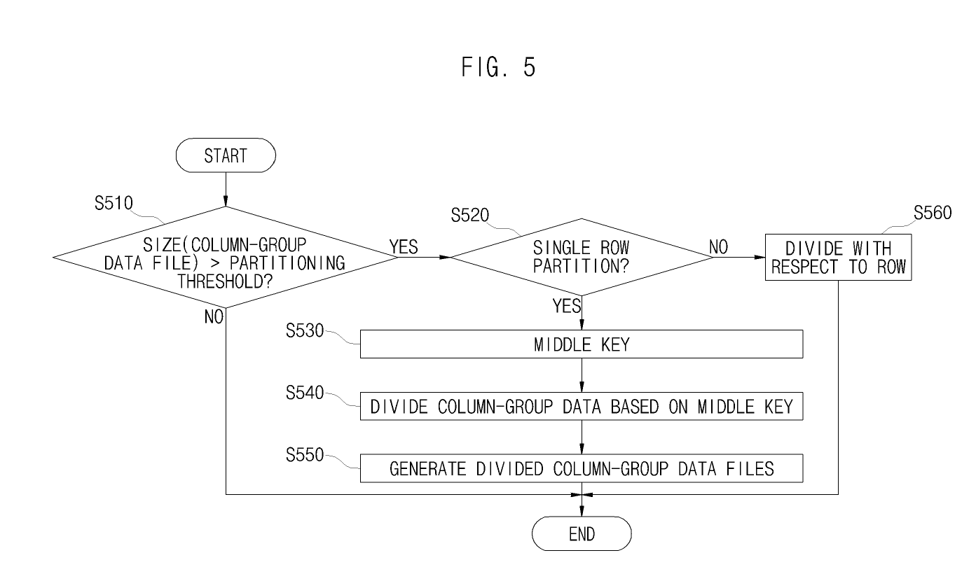

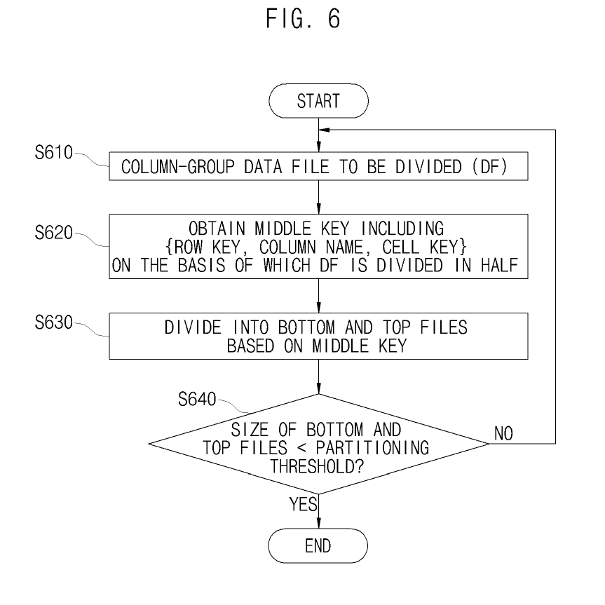

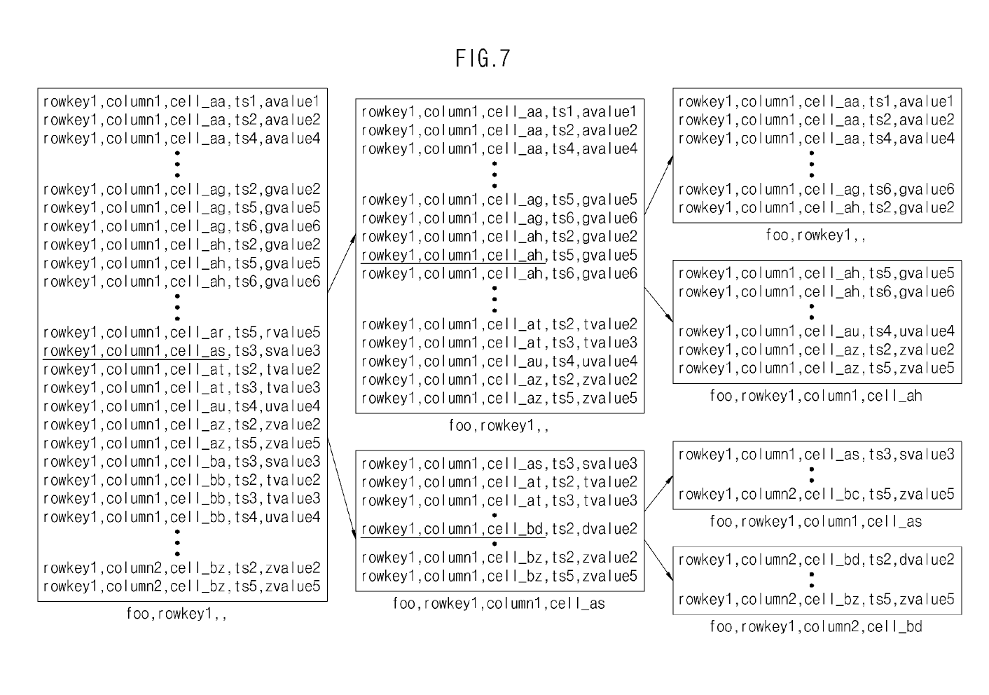

Another embodiment of the present invention will be described with reference to FIGS. 5 to 7. FIG. 5 is a flowchart illustrating a column-based data managing method according to another embodiment of the present invention. FIG. 6 is a flowchart illustrating a method of dividing a column-group data file with respect to middle key in a column-based data managing apparatus and method according to another embodiment of the present invention. FIG. 7 is a view illustrating an example of dividing a column-group data in a column-based data managing apparatus and method according to another embodiment of the present invention.

Referring to FIG. 5, a column-based data managing method according to another embodiment determines whether the size of a column-group data file exceeds a partitioning threshold within a partition including one or more column group data (S510). If the size is determined to exceed the partitioning threshold, the column-group data is determined to correspond to a single-row partition (S520), and if the single-row partition, a middle key is obtained that divides in half the column-group data file to be divided because of exceeding the partitioning threshold (S530) and the column-group data is divided with respect to the middle key (S540). Further, the column-group data is divided to generate a divided column-group data file (S550). Unless the partition is a single-row partition, the partition is divided with respect to the row (S560).

Accordingly, the column-based data managing method may divide the column-group data with respect to the middle key when the size of column-group data file is larger than the partitioning threshold, and effectively manage the column-based data. Further, the method may solve the problem that the size of column-group data is limited to the partitioning threshold in the case of the column-group data is a single-row partition and allows for effective management of a row having a size larger than the partitioning threshold.

The middle key may include at least one of a row key, a column name, and a cell key.

Further, when the column-group data is divided to generate divided column-group data files (S550), the name of the middle key may be added to the name of the divided column-group data files to generate divided column-group data files.

FIG. 6 illustrates dividing a column-group data file with respect to a middle key in a column-based data managing apparatus and method according to another embodiment of the present invention. A middle key is obtained with respect to a column-group data file DF to be divided (S610), which is a basis for dividing the file DF in half (S620). The middle key may include at least one of a row key, a column name, and a cell key. After obtaining the middle key, the column-group data file DF is divided based on the middle key into a BOTTOM file that has a smaller value with respect to the middle key and a TOP file that has an equal or larger value with respect to the middle key (S630).

Thereafter, steps S610 to S640 are repetitively performed on the BOTTOM file and TOP file so that dividing continues to be conducted until the size of BOTTOM file and TOP file is smaller than a partitioning threshold (S640). As steps S610 to S640 are repetitively performed, the BOTTOM file or TOP file becomes the column group data file DF to be divided (S610).

Accordingly, the column-based data managing apparatus and method according to the embodiment may effectively divide the column-group even when the size of a specific column-group data file in a single-row partition is large.

The column-group data division may be conducted after a compaction process is performed.

Dividing the file DF into the BOTTOM file and TOP file is given for purpose of illustration only and may be varied depending on design by those skilled in the art without intending to define technical features of the present invention or limit the components.

Further, the name of the BOTTOM file and TOP file may be changed, for example, to include at least one of a row key, a column name, and a cell key. The name of the file storing the BOTTOM may use the name of the file before dividing and the name of the file storing the TOP may be determined by using a middle key that is a basis for division. If the middle key used for division omits a specific field value (e.g., cell key), the corresponding value may be Null.

Referring to FIG. 7, it is assumed that the column-group includes column 1 and column 2. If the name of column-group data file to be divided is “foo,rowkey1,,”, a middle key that may divide the column-group data in two, for example, {rowkey1, column1, cell_as} is obtained. In this case, the column-group data file is the one that has been subjected to compaction. After obtaining the middle key, the column-group data is divided with respect to the middle key to store the part having a value smaller than the middle key to a file “foo,rowkey1,,” (BOTTOM file) as BOTTOM and the other part having a value equal or larger to/than the middle key to a file “foo,rowkey1,column1,cell_as” (TOP file) as TOP. The size of files “foo,rowkey1,,” and “foo,rowkey1, column1,cell_as” are larger than the partitioning threshold, and thus the column-group data is divided with respect to middle keys “{foo,rowkey1,column1,cell_ah}” and “{foo,rowkey1,column1, cell_bd}” to generate divided column-group data files whose names are “foo,rowkey1,,”, “foo,rowkey1,column1,cell_ah”, “foo,rowkey1,column1,cell_as”, and “foo,rowkey1,column1, cell_bd”.

In the above-described method, the column-based data managing apparatus and method according to the embodiment of the present invention may find the middle key dividing a column-group data file to be divided in half and divide the column-group data based on the middle key, and thus may provide effective column-based data management.

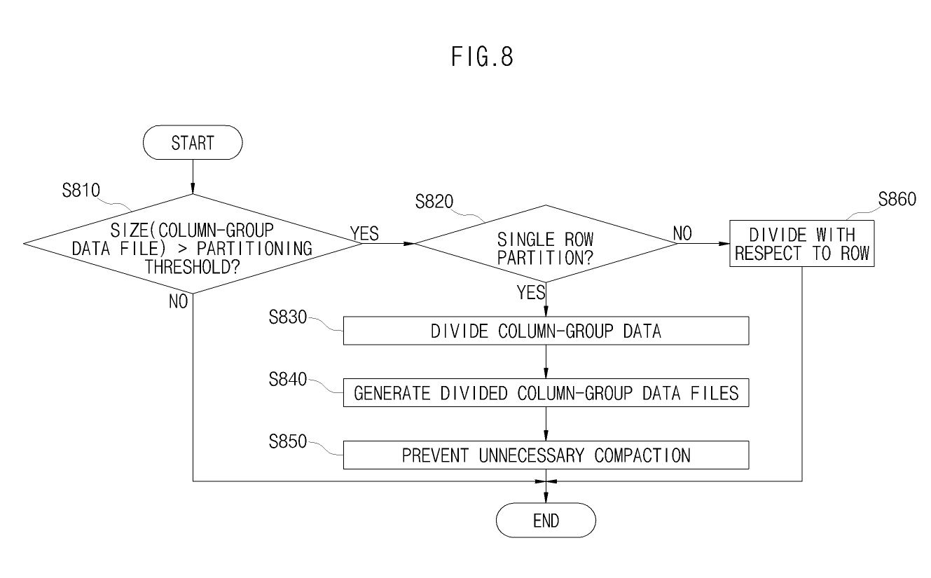

Another embodiment of the present invention will be described with reference to FIGS. 7 and 8. FIG. 7 is a view illustrating an example of dividing column-group data in a column-based data managing apparatus and method according to another embodiment of the present invention. FIG. 8 is a flowchart illustrating a column-based data managing method according to another embodiment of the present invention.

Referring to FIG. 8, the column-based data managing method according to the embodiment determines whether the size of a column-group data file exceeds a partitioning threshold in a partition having one or more column-group data (S810). As a consequence, if the size exceeds the partitioning threshold, it is determined whether the column-group data is a single row partition (S820), and if the single row partition, the column-group data is divided (S830) to generate divided column-group data files (S840). In this case, unnecessary compaction is prevented from being performed on the divided column-group data files (S850). Unless the column-group data is a single row partition, the partition is divided with respect to the row (S860).

If compaction is unnecessarily performed on the divided column-group data files, column-groups are generated again from the divided column-group data files and thus unnecessary column-group data files are generated. Accordingly, unnecessary compaction should be avoided.

The column-based data managing apparatus and method according to an embodiment of the present invention treat divided column-group data files, which were already subjected to compaction as a single row, as a single column-group data file while counting the number of the column-group data files to determine whether compaction should be conducted. By doing so, it may be possible to prevent unnecessary compaction on the column-group data files treated as a single file.

Referring to FIG. 7, it is assumed that compaction is carried out when the number of column-group data files is three or more. Even though there exist three files, such as “foo,rowkey1,,”, “foo,rowkey1,column1,cell_ah”, and “goo,,,”, to store the column groups of a specific partition, the files “foo,rowkey1,,”, “foo,rowkey1, column1, cell_ah” are treated as a single column-group data file. Accordingly, two column group data files are assumed to be present, and thus, unnecessary compaction may be prevented.

Accordingly, the column-based data managing method may divide the column-group data when the size of column-group data files in a single-row partition is in excess of the partitioning threshold and prevent unnecessary compaction, thus effectively managing the column-based data by using the divided column-group data.

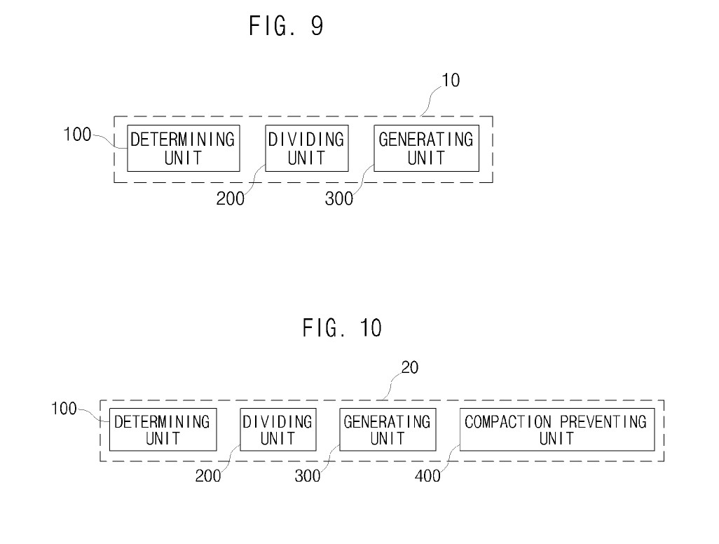

Another embodiment of the present invention will be described with reference to FIG. 9. FIG. 9 is a block diagram illustrating a column-based data searching apparatus according to another embodiment of the present invention.

Referring to FIG. 9, the column-based data searching apparatus 10 according to the embodiment may include a determining unit 100, a dividing unit 200, and a generating unit 300.

The determining unit 100 determines whether the size of column-group data file exceeds a partitioning threshold.

If the size exceeds the partitioning threshold, the dividing unit 200 divides the column group data.
The generating unit 300 generates the divided column group data files.

The determining unit 100 may determine whether, among the column-group data files, the data file having the largest data size has a size of more than the partitioning threshold.

The dividing unit 200 may obtain a middle key that allows the column-group data file whose size is larger than the partitioning threshold to be divided in half, and divided the file based on the middle key.

The dividing unit 200 may repeatedly divide the column-group data file until the size of the data file is smaller than the partitioning threshold.

The generating unit 300 may generate the divided column-group data files by adding at least one of the middle key, the name of the column-group data file prior to dividing, and the row key, column name, and cell key of the column-group data file prior to dividing to the names of the divided column-group data files.

Accordingly, the column-based data managing apparatus according to the embodiment may divide the column-group data when the size of the column-group data file in a single row partition is in excess of the partitioning threshold. Further, the apparatus may effectively manage the column-based data by using the divided column-group data.

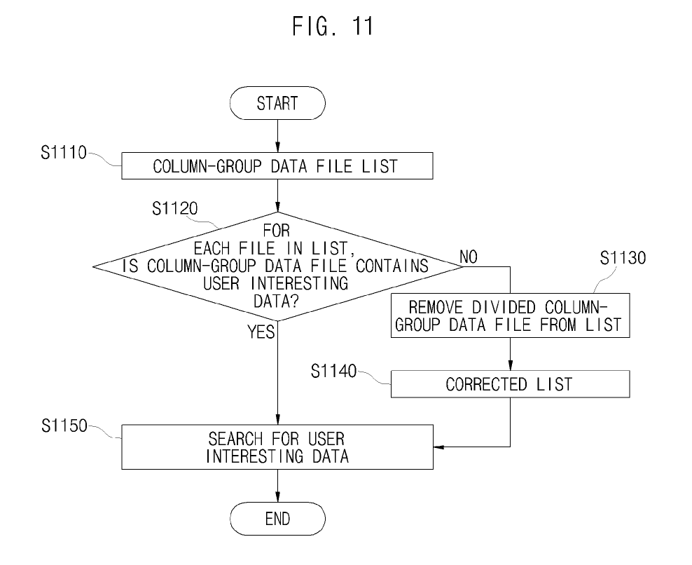

Another embodiment of the present invention will be described with reference to FIG. 10. FIG. 10 is a block diagram illustrating a column-based data searching apparatus according to another embodiment of the present invention.

Referring to FIG. 10, the column-based data searching apparatus 20 according to the embodiment may include a determining unit 100, a dividing unit 200, a generating unit 300, and a compaction preventing unit 400.

The same elements as those according to the embodiment of FIG. 9 are assigned with the same reference numerals and the detailed descriptions will be omitted.

FIG. 10 illustrates the column-based data searching apparatus further includes the compaction preventing unit 400.

The compaction preventing unit 400 prevents unnecessary compaction from being performed on the divided column-group data files.

In determining whether unnecessary compaction is performed, the compaction preventing unit 400 counts the number of column-group data files and treats the divided column-group data files, which have been already subjected to compaction as a single row partition, as a single column-group data file. Accordingly, the column-group data files treated as a single file may be prevented from being unnecessarily subjected to compaction.

Accordingly, the column-based data managing apparatus according to the embodiment may divide the column-group data when the size of the column-group data file is in excess of the partitioning threshold and prevent unnecessary compaction. Further, the apparatus may effectively manage the column-based data by using the divided column-group data.

Another embodiment of the present invention will be described with reference to FIG. 11. FIG. 11 is a flowchart illustrating a column-based data searching method according to another embodiment of the present invention.

Referring to FIG. 11, the column-based data searching method according to the embodiment provides a method of searching divided column-group data files by using a column-based data managing method to search for an object desired by a user.

First, a list of column-group data files is obtained (S1110). Also, it is determined whether each column-group data file in the list is a divided column-group data file including user interesting data (S1120). The divided column group data file without user interesting data is removed (S1130) and a corrected list is obtained (S1140). Thereafter, user interesting data is searched based on the corrected list (S1150).

As such, the column-based data searching method according to the embodiment may search for user interesting data using the corrected list from which divided column-group data files without user interesting data have been excluded.

The step (S1120) may include determining whether user interesting data is included from the names of the divided column-group data files.

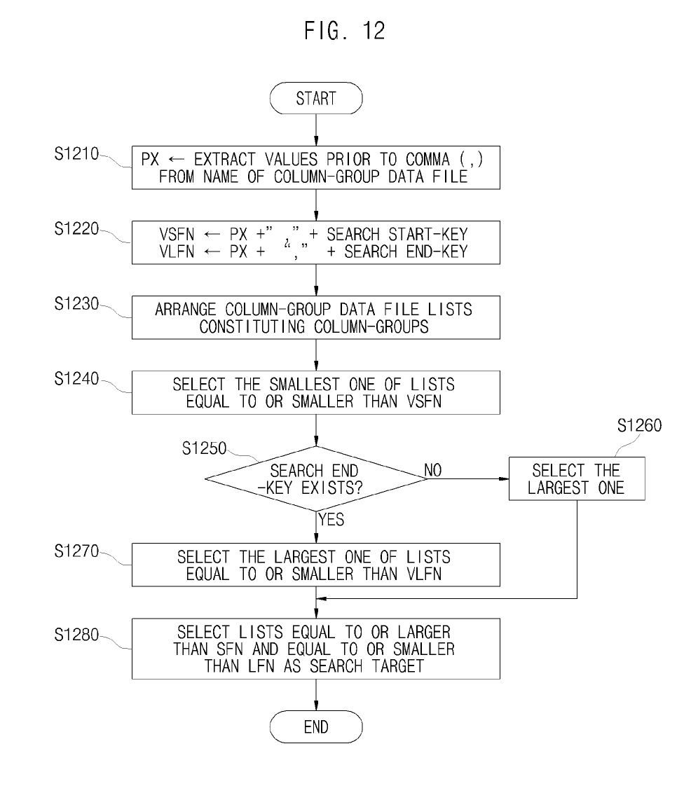

Another embodiment of the present invention will be described with reference to FIG. 12. FIG. 12 is a flowchart illustrating a method of determining whether a divided column-group data file includes user interesting data in a column-based data searching method according to another embodiment of the present invention.

Referring to FIG. 12, the column-based data searching method according to the embodiment provides a method of searching for a divided column-group data file by using a column-based data managing method in order to search for user interesting data. First, the name of a column-group data file prior to dividing is extracted from the name of divided column-group data to obtain a list of column-group data files constituting a partition. Further, at least one of a search start-key and a search end-key is used to determine whether each column-group data file in the list is a divided column-group data file including user interesting data. If the column-group data file does not include user interesting data, then the divided column-group data file is removed to obtain a corrected list. Thereafter, the corrected list is used to search for user interesting data.

Referring to FIG. 12, the values positioned prior to the first comma are extracted from the names of divided column-group data files (S1210). The extracted value refers to PX (prefix). A virtual smallest file name (hereinafter, “VSFN”) and a virtual largest file name (hereinafter, “VLFN”) are obtained to have the same type as that of the name of the divided column-group data file to compare the column-group data files with each other by using the names of the divided column-group data files (S1220).

The VSFN is constituted by performing string concatenation between the comma(,) and the search start-key which is a search starting point of the divided column-group data in the PX and the VLFN is constituted by performing string concatenation between the comma and search end-key in the PX, thereby obtaining a list of the divided column-group data files constituting the column-groups (S1230).

In the arranged data file name list, the largest name of names equal to or smaller than the VSFN is selected as a smallest file name to be returned (hereinafter, “SFN”) (S1240).

It is determined whether or not there is the search end-key that is the search end part of the divided column-group data (S1250).

In the absence of the search end-key, the largest in the column-group data file list is selected as LFN (S1260).

If a search end-key, the largest name of names equal to or smaller than the VLFN is selected as a largest file name to be returned (hereinafter, “LFN”) (S1270).

The search start-key and the search end-key may include at least one of a row key, a column name, and a cell key. Further, the search start-key and the search end-key may be inputted by a user.

The name equal to or larger than the SFN and equal to or smaller than the LFN may be selected as a divided column-group data file list including user interesting data (S1280). At this time, the list is returned as a corrected list.

Accordingly, the column-based data searching method according to the embodiment may reduce the number of disk access by decreasing the column group data files to be scanned.

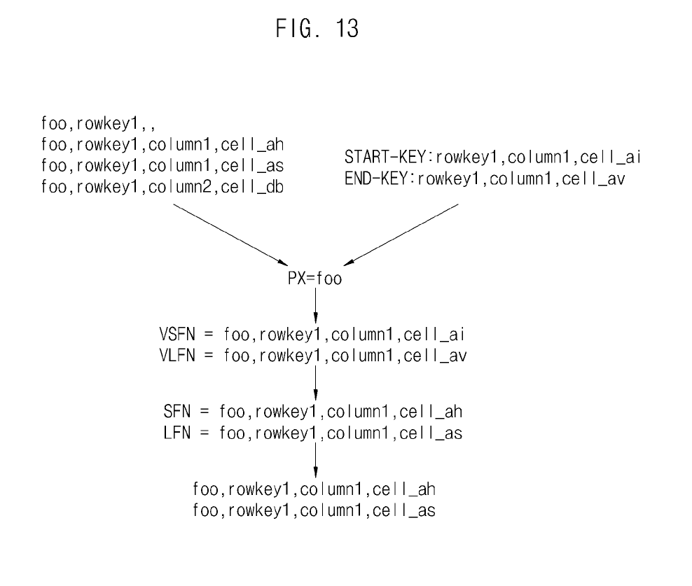

Another embodiment of the present invention will be described with reference to FIG. 13. FIG. 13 is a view illustrating an example of a method of determining whether a divided column-group data file includes user interesting data in a column-based data searching method according to another embodiment of the present invention.

FIG. 13 exemplifies designating a search target when a search start-key {rowkey1,column1,cell_ai} and a search end-key {rowkey1,column1,cell_av}, and the divided column-group data files whose names are “foo,rowkey1,,”, “foo,rowkey1,column1,cell_ah”, “foo,rowkey1,column1,cell_as”, and “foo,rowkey1,column1,cell_bd” are entered.

To begin with, a list of the divided column-group data files is obtained. Referring to FIG. 13, “foo,rowkey1,,”, “foo,rowkey1,column1,cell_ah”, “foo,rowkey1,column1,cell_as”, and “foo,rowkey1,column1,cell_bd” become the divided column-group data files of the list.

To extract a corrected list including the column-group data files which can be a search target from the divided column-group data files, the values positioned prior to the first comma “,” are extracted from the names of the divided column-group data files. The PX value is “foo” as shown in FIG. 13.

Further, the VSFN and the VLFN are constituted.

Referring to FIG. 13, “foo,rowkey1,column1,cell_ai” as the VFSN and “foo,rowkey1,column1,cell_av” as the VLFN are selected, respectively.

Further, the divided column-group data file in the list and the VSFN are compared to each other to obtain the SFN, so that “foo,rowkey1,column1,cell_ah” is selected as the SFN.

If there exist a search end-key, the largest one of values equal to or smaller than the VLFN is selected as the LFN. When no search end-key exists, the largest value in the list is selected as the LFN. Referring to FIG. 13, “foo,rowkey1,column1,cell_as” is selected as the LFN. Values equal to or larger than the SFN and equal to or smaller than the LFN are selected as lists of divided column-group data files including user interesting data, and the lists are returned as corrected lists.

The column-based data searching method according to the embodiment may search for user interesting data using the corrected list from which divided column-group data files without the user interesting data are excluded.

While certain embodiments have been described above, it will be understood by those skilled in the art that the embodiments described can be modified into various forms without changing technical spirits or essential features. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A column-based data managing method comprising:
in a partition including one or more column-group data, determining whether the size of the column-group data file exceeds a partitioning threshold;
dividing the column-group data if the size exceeds the partitioning threshold; and
generating divided column-group data files.

2. The column-based data managing method according to claim 1, wherein the dividing includes determining whether the column-group data correspond to a single row partition and if the single row partition, dividing the column-group data.

3. The column-based data managing method according to claim 1, wherein the dividing further includes obtaining a middle key that divides in half the column-group data files that exceed the partitioning threshold to divide the column-group data based on the middle key.

4. The column-based data managing method according to claim 3, wherein the middle key includes any one of a row key, a column name, and a cell key.

5. The column-based data managing method according to claim 3, wherein the generating includes adding a name of the middle key to names of the divided column-group data files to generate the divided column-group data files.

6. The column-based data managing method according to claim 2, further comprising:
preventing unnecessary compaction from being performed on the divided column-group data files, wherein the compaction gets rid of meaningless data to optimize utilization of a storage and combines the column-group data files into a single file.

7. The column-based data managing method according to claim 6, wherein in counting the number of column-group data files to determine whether or not to perform unnecessary compaction, the preventing includes treating the divided column-group data files that have been already subjected to compaction with respect to a single row as a single column-group data file, thereby preventing the column-group data files treated as the single file from being subjected to unnecessary compaction.

8. The column-based data managing method according to claim 1, wherein the determining includes determining whether the size of the largest one of the column group data files within a specific partition exceeds a partitioning threshold.

9. The column-based data managing method according to claim 1, wherein the generating includes adding at least one of names, row keys, column names, and cell keys of column-group data files prior to dividing to names of divided column-group data files to generate the divided column-group data files.

10. The column-based data managing method according to claim 1, wherein the generating includes adding information on a range of the column-group data files to names of the divided column-group data files to generate the divided column-group data files.

11. The column-based data managing method according to claim 1, wherein the dividing includes repeatedly dividing the column-group data until the size of the column-group data files is smaller than the partitioning threshold.

12. A column-based data managing apparatus comprising:
a determining unit that the size of the largest one of column-group data files within a specific partition subjected to compaction exceeds to a partitioning threshold;
a dividing unit that, in the case of exceeding the partitioning threshold, divides the column-group data; and
a generating unit that generates divided column-group data files.

13. The column-based data managing apparatus according to claim 12, wherein the dividing unit obtains a middle key that divides in half column-group data files that exceed the partitioning threshold, and divides the column-group data based on the middle key.

14. The column-based data managing apparatus according to claim 13, wherein the generating unit adds at least one of the middle key, names of the column- group data files prior to dividing, and row keys, column names, and cell keys of column-group data prior to dividing to names of divided column-group data files to generate the divided column-group data files.

15. The column-based data managing apparatus according to claim 12, further comprising:
a compaction preventing unit that prevents unnecessary compaction from being performed on the column-group data files,
wherein in counting the number of column-group data files to determine whether or not to perform unnecessary compaction, the compaction preventing unit treats the divided column-group data files that have been already subjected to compaction with respect to a single row as a single column-group data file, thereby preventing the column-group data file treated as the single column-group data file from being subjected to unnecessary compaction.

16. The column-based data managing apparatus according to claim 12, wherein the dividing unit repeatedly divides the column-group data until the size of the column-group data files is smaller than the partitioning threshold.

17. A column-based data searching method to search for divided column-group data files using a column-based data managing method in order to find user interesting data, the searching method comprising:
obtaining a list of divided column-group data files constituting a partition;
determining whether each divided column-group data file in the list includes user interesting data;
removing divided column-group data files that do not include user interesting data to obtain a corrected list; and
searching for user interesting data by using the corrected list.

18. The column-based data searching method according to claim 17, wherein the determining includes determining whether or not to include user interesting data by using names of the divided column-group data files.

19. The column-based data searching method according to claim 17, wherein the names of the divided column-group data files are formed based on a middle key used for dividing the column-group data files, wherein
the determining is performed based on the middle key.

20. The column-based data searching method according to claim 17, wherein the determining is performed based on at least one of a search start-key and a search end-key.
